(19) United States
(12) Patent Application Publication
(10) Pub. No.: US 2010/0110034 A1
(43) Pub. Date: May 6, 2010

(54) Touch Panel and Quick Scrolling Method Thereof

(75) Inventor: Chao-Ching Teng, Guishan Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DARFON ELECTRONICS CORP., Taoyuan (TW)

(21) Appl. No.: 12/610,449

(22) Filed: Nov. 2, 2009

(30) Foreign Application Priority Data
Nov. 6, 2008 (TW) 97142954

(51) Int. Cl. G06F 3/041; G06F 3/048

(52) U.S. Cl. 345/173; 715/784

(57) ABSTRACT

A touch panel and a quick scrolling method thereof are disclosed. The quick scrolling method includes the steps stated below. Firstly, a first location of an object at a fist moment of time is detected by a touch panel. Next, a second location of the object at a second moment of time is detected by the touch panel. Then, a moving speed of the object is calculated according to a time difference between the fist moment and the second moment of time and a distance between the first location and the second location. After that, the moving speed is compared to a threshold value, and if the moving speed is greater than the threshold value, then a scroll of a display window will be moved fast.

This application claims the benefit of Taiwan application Serial No. 97142954, filed Nov. 6, 2008, the subject matter of which is incorporated herein by reference.

### BACKGROUND OF THE INVENTION

1. Field of the Invention

The invention relates in general to a touch panel, and more particularly to a touch panel and a quick scrolling method thereof.

2. Description of the Related Art

In addition to the keyboard and the mouse, the touch panel provides another input method for the user. With the touch panel, the user can operate an electronic device by finger touch or finger sliding, making the communication between the user and the electronic device more user-friendly and thus becoming very popular in the market. Currently, the touch panel technology has been widely used in electronic devices such as ATM, mobile phone, digital camera, desktop computer, notebook computer, and handheld game device.

Take notebook computer for example. When the user would like to scroll the display window, the user normally controls the scroll to move upward, downward, leftward or rightward with a mouse or the roller of the mouse. When the user controls the movement of the scroll with a touch panel, the cursor has to be shifted to the location of the scroll first so as to control the movement of the scroll, making the operation complicated.

### SUMMARY OF THE INVENTION

The invention is directed to a touch panel and a quick scrolling method thereof. Whether to start the fast scrolling mechanism is determined according to the state of an object on the touch panel, making the operation more convenient to the user.

According to a first aspect of the present invention, a quick scrolling method is provided. The quick scrolling method includes the steps stated below. Firstly, a first location of an object at a fist moment of time is detected by a touch panel. Next, a second location of the object at a second moment of time is detected by the touch panel. Then, a moving speed of the object is calculated according to a time difference between the fist moment and the second moment of time and a distance between the first location and the second location. After that, the moving speed is compared to a threshold value, and if the moving speed is greater than the threshold value, then a scroll of a display window will be moved fast.

According to a second aspect of the present invention, a touch panel is provided. The touch panel includes a panel body, many sensing elements, a register unit, a calculation unit, a comparison unit and a processing unit. The panel body has at least one scrolling area. The sensing elements are disposed in the scrolling area of the panel body for detecting the location of an object. The sensing elements detect a first location of the object at a fist moment of time and further detect a second location of the object at a second moment of time. The register unit has many register areas in which the data including the fist moment of time, the second moment of time, the first location and the second location are temporarily stored. The calculation unit is for calculating a time difference between the fist moment of time and the second moment of time and a distance between the first location and the second location to further calculate a moving speed of the object. The comparison unit is for comparing the moving speed to a threshold value. The processing unit is for generating a fast moving signal to move a scroll of a display window fast when the comparison unit determines that the moving speed is greater than the threshold value.

The invention will become apparent from the following detailed description of the preferred but non-limiting embodiments. The following description is made with reference to the accompanying drawings.

### BRIEF DESCRIPTION OF THE DRAWINGS

FIG. 1 shows a touch panel according to a preferred embodiment of the invention;

FIG. 2 shows a notebook computer;

FIG. 3 shows a circuit block diagram of the elements of the touch panel of FIG. 1;

FIG. 4 shows a flowchart of a quick scrolling method according to a preferred embodiment of the invention;

FIGS. 5 and 6 show two flowcharts of the method for stopping the fast moving of a scroll; and

FIG. 7 shows a flowchart of touch control of the overall touch panel of FIG. 1.

### DETAILED DESCRIPTION OF THE INVENTION

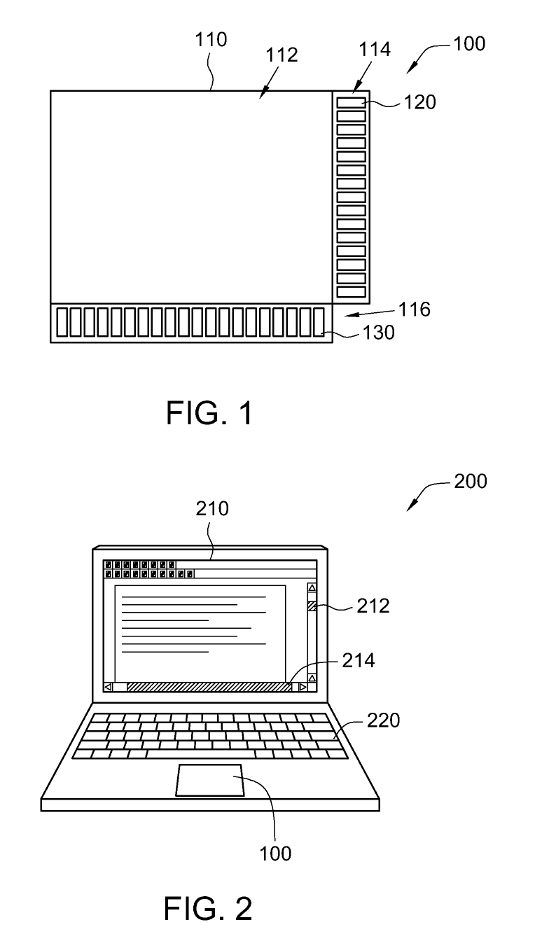

Refer to FIGS. 1 and 2. FIG. 1 shows a touch panel according to a preferred embodiment of the invention. FIG. 2 shows a notebook computer. As indicated in FIG. 1, the touch panel 100 includes a panel body 110, which has a main touch area 112 and at least one scrolling area. In the present embodiment of the invention, a first scrolling area 114 and a second scrolling area 116 are perpendicular to each other and are located at two edges of the main touch area 112, wherein, the first scrolling area 114 is a vertical scrolling area, and the second scrolling area 116 is a horizontal scrolling area. The touch panel 100 can be used in an electronic device, such as the notebook computer 200 of FIG. 2, for controlling the cursor (not shown) of the display window 210 and executing the functions of the keyboard 220 or the mouse (not shown) of the notebook computer 200.

The touch panel 100 further includes many sensing elements disposed within the scrolling area of the panel body 110. Preferably, the sensing elements are linearly disposed. As indicated in FIG. 1, the first scrolling area 114 has many sensing elements 120 disposed therein, and the second scrolling area 116 has many sensing elements 130 disposed therein. The sensing elements 120, being vertically arranged to be in line with the direction of the first scrolling area 114, are capable of detecting the vertical location of the object in the first scrolling area 114. The sensing elements 130, being horizontally arranged to be in line with the direction of the second scrolling area 116, are capable of detecting the horizontal location of the object in the second scrolling area 116. Therefore, the sensing elements 120 and 130 further control the movement of the scrolls 212 and 214 of the display window 210.

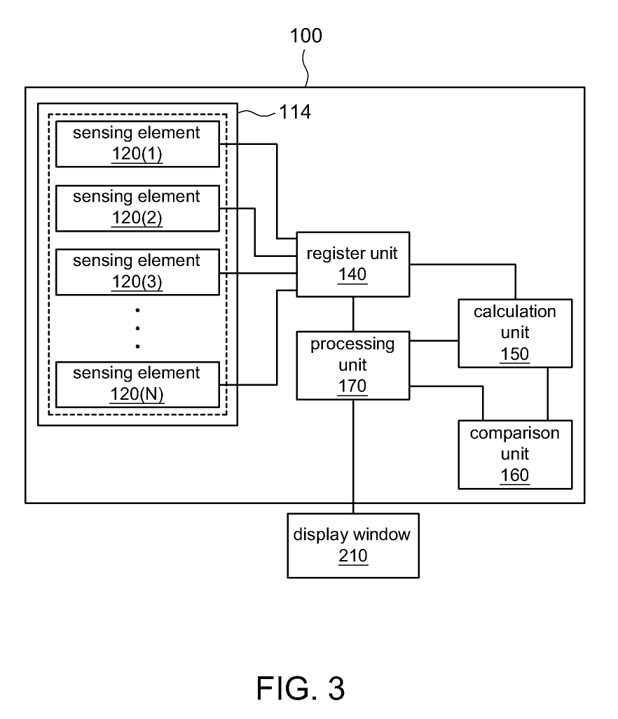

Further referring to FIG. 3, a circuit block diagram of the elements of the touch panel of FIG. 1 is shown. As the functions of the second scrolling area 116 are substantially the same as that of the first scrolling area 114, only the first scrolling area 114 is illustrated in FIG. 3 to simplify the elaboration of the embodiment. As indicated in FIG. 3, the sensing elements 120(1), 120(2)-120(N) are sequentially arranged in the first scrolling area 114. The touch panel 100 further includes a register unit 140, a calculation unit 150, a comparison unit 160 and a processing unit 170.

The sensing elements 120 (or 130) are capacitor elements, for example. When an object, such as a finger, approaches any of the sensing elements and makes the capacitance change, the sensing elements temporarily store the location information of the object in the register areas of the register unit 140. The calculation unit 150 calculates a moving speed of the object according to the information stored in the register unit 140. The comparison unit 160 compares the moving speed to a threshold value. The processing unit 170 determines whether to drive the scroll 212 (or 214) of the display window 210 to move fast according to the results of comparison made by the comparison unit 160.

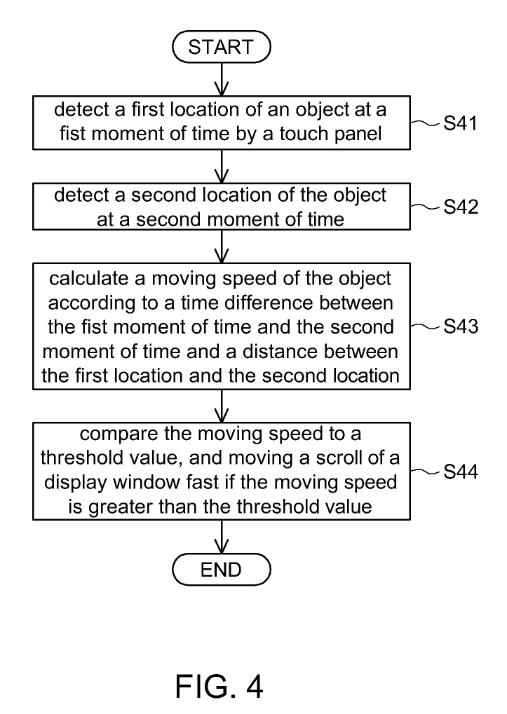

Referring to FIG. 4, a flowchart of a quick scrolling method according to a preferred embodiment of the invention is shown. The quick scrolling method includes steps S41˜S44 elaborated below one by one.

Firstly, the method begins at step S41, a first location of an object at a fist moment of time is detected by the touch panel. To avoid the errors in determining the location of the object, a default value can be set as a criterion for determining whether a sensing element detects the object. For example, if the capacitance change in the location of a sensing element exceeds the default value, then the signal value of the sensing element is set as 1, and the signal values of the remaining sensing elements whose capacitance changes do not exceed the default value are set as 0. Presumably, in the first moment of time, if the sensing element 120(2) senses the existence of the object and has a larger capacitance change, then the signal value of the sensing element 120(2) is set as 1, and the signal values of the remaining sensing elements 120(1), 120(3)˜120(N) are set as 0, and the first item of data generated by the sensing elements 120(1)˜120(N) and the information of the fist moment of time are stored in the register areas of the register unit 140.

Next, the method proceeds to step S42, a second location of the object at a second moment of time is detected. Presumably, in the second moment of time, the sensing element 120(13) senses the existence of the object and has a larger capacitance change, then the signal value of the sensing element 120(13) is set as 1, the signal values of the remaining sensing elements 120(1)˜120(12) and 120(14)˜120(N) are set as 0, and the second item of data generated by the sensing elements 120(1)—120(N) and the information of the second moment of time are stored in the register areas of the register unit 140.

Then, the method proceeds to step S43, a moving speed of the object is calculated according to a time difference between the fist moment of time and the second moment of time and a distance between the first location and the second location. In the present step, the calculation unit 150 calculates the moving speed of the object according to the data stored in the register unit 140. Presumably, the first location of the object at the fist moment of time corresponds to the location of the sensing element 120(2), and the second location of the object at the second moment of time corresponds to the location of the sensing element 120(13), then the calculation unit 150 calculates to determine that the object moves for a distance of about 12 sensing elements such as 12 frames for example. The calculation unit 150 further calculates to determine that the time difference between the fist moment of time and the second moment of time is 1 second. Based on the number of frames that the object has moved (12 frames) and the time difference (1 second), the calculation unit 150 calculates to determine that the moving speed of the object is 12 frames per second.

Next, the method proceeds to step S44, the moving speed is compared to a threshold value, and if the moving speed is greater than the threshold value, then the scroll of a display window is moved fast. The threshold value is a criterion for determining whether to start the mechanism of fast scrolling, and can be set according to actual situations and needs. The threshold value of the present embodiment of the invention is 10 frames per second, for example. Once the calculation unit 150 has calculated a moving speed of the object, the comparison unit 160 compares the moving speed to the threshold value. Because the moving speed of the object (12 frames per second) is greater than the threshold value (10 frames per second), the processing unit 170 generates a fast moving signal for driving the scroll of the display window 210 to move fast.

Besides, the processing unit 170 can further determine the moving direction of the scroll according to the information of the first location recorded by the register unit 140 at the fist moment of time and the information of the second location recorded by the register unit 140 at the second moment of time. For example, as the object shifts from the location of the sensing element 120(2) to the location of the sensing element 120(13), it is determined that the object moves downward, and correspondingly, the moving direction of the scroll is downward as well, and the scroll 212 of FIG. 1 will move downward fast. In other occasions of use, the moving direction of the scroll can be upward, leftward or rightward.

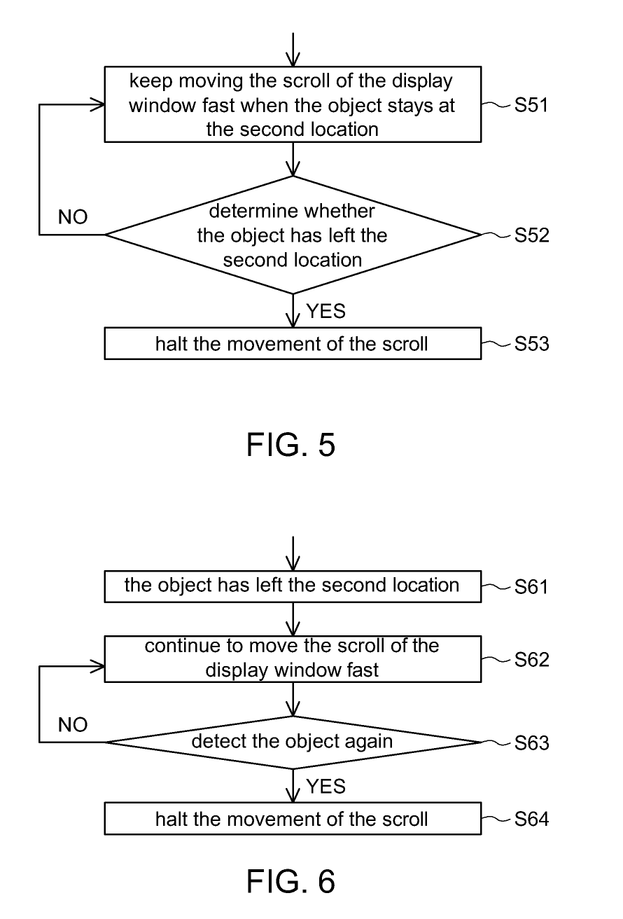

After step S44, the processing unit 170 can further determine whether to stop the fast movement of the scroll according to the state of the object detected by the touch panel 100. Referring to FIG. 5 and FIG. 6, two flowcharts of the method for stopping the fast moving of a scroll are shown.

As indicated in step S51 of FIG. 5, when the object stays at the second location, the scroll of the display window continues to move fast. The object is, for example, a finger. In FIG. 3, when the finger shifts to a second location corresponding to the sensing element 120(13) from a first location, such as the first location corresponding to the sensing element 120(2), along the touch panel 100 and stays at the second location, the scroll continues to move fast.

The sensing elements 121(1)˜121(N) incessantly sense whether an object exists or not. When the finger stays at the second location, the corresponding sensing element of the finger incessantly generates signals, so that the processing unit 170 continues to move the scroll of the display window fast according to the signals being generated.

Next, the method proceeds to step S52, whether the object has left the second location is determined. After the object has stayed at the second location for a period of time, when the sensing element at the second location, such as the sensing element 120(13) stops outputting signal (or the signal value is 0), this implies that the object has been removed from the touch panel 100, and the method skips to step S53, the movement of the scroll is immediately halted. Otherwise, the method returns to step S52, the scroll of the display window continues to move fast.

According to the method disclosed in FIG. 5, once the object has left the touch panel 100 from the second location, the movement of the scroll is immediately halted. Another method elaborated below discloses that even thought the object has left from the second location, the scroll keeps moving fast.

As indicated in step S61 of FIG. 6, after the object has been shifted to the second location from the first location, when the object directly lefts the touch panel 100 from the second location, the processing unit 170 still drives the scroll to move fast continuously as indicated in step S62. Meanwhile, the sensing elements 120(1)˜120(N) still incessantly detect whether an object exists or not.

As indicated in step S63, whether an object is detected is determined. Take finger for example. After the finger has left from the second location, if the touch panel 100 is again touched or pressed by the finger, then the sensing elements of the touch panel 100 will again generate signals. Meanwhile, as indicated in step S64, the processing unit 170 can halt the movement of the scroll according to the generated signals. If the finger does not touch or press the touch panel 100 again after having left the second location, then the scroll can continue to move fast as indicated in step S62.

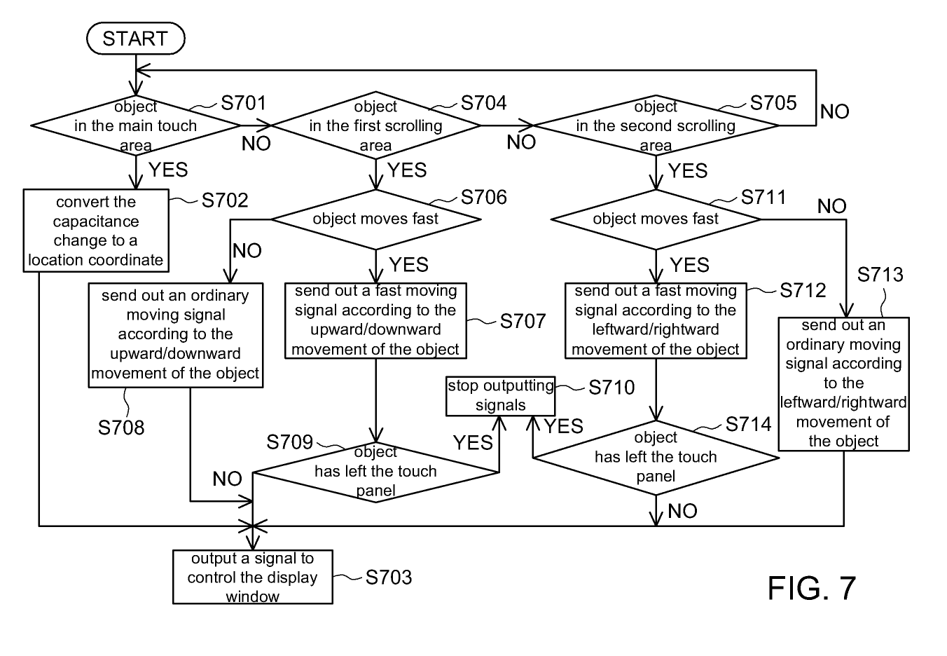

According to the above disclosure, the touch panel 100 quickly starts the fasting moving of the scroll 212 and 214 of the display window 210 through the first scrolling area 114 and the second scrolling area 116. Also, referring to FIG. 7, a flowchart of touch control of the overall touch panel of FIG. 1 is shown.

Firstly, the method begins at step S701, whether an object is in the main touch area 112 is detected. When the user operates the touch panel 100, the object (such as a finger) normally slides on the main touch area 112. If it is determined that the object is in the main touch area 112, the capacitance change in the sensing element is converted to a location coordinate as indicated in step S702. Next, the method proceeds to step S703, a signal is outputted to control the state of the display window 210 such as the location of a cursor.

If the object is not on the main touch area 112, the method proceeds to step S704, whether the object is in the first scrolling area 114 is determined, otherwise, the method proceeds to step S705, whether the object is in the second scrolling area 116 is determined.

In step S704, if the object is in the first scrolling area 114, the method proceeds to step S706, whether the object moves fast is determined. Step S706 is already elaborated in the explanation of FIG. 4, and is not repeated here. If it is determined that the object moves fast, the method proceeds to step S707, a fast moving signal generated by the processing unit 170 (referring to FIG. 3) is sent out according to the upward or downward movement of the object.

In step S706, if the object does not move fast, the method proceeds to step S708, an ordinary operation of the scroll is executed. Meanwhile, the processing unit 170 sends out an ordinary moving signal according to the upward or downward movement of the object, and then the method skips to step S703. The scroll 212 (referring to FIG. 2) of the display window 210 will move upward or downward along with the movement of the object so as to scroll the frame of the display window 210.

After step S707, the method proceeds to step S709, whether the object has left the touch panel 100 is immediately determined. If yes, then the method skips to step S710, the processing unit 170 stops outputting signals so as to halt the movement of the scroll. Step 710 is similar to the process of FIG. 5, and is not repeated here. If the object does not leave the touch panel 100, then a signal is outputted to control the state of the display window 210 as indicated in step S703.

If the object is neither in the main touch area 112 nor in the first scrolling area 114, then the method proceeds to step S705, whether the object is in the second scrolling area 116 is determined. If the object is in the second scrolling area 116, then the state of the object is further determined, and the subsequent steps S711˜S714 are executed. Step S711˜S714 are substantially similar to step S706˜S709 except that the first scrolling area 114 controls the upward/downward movement of the scroll 212 but the second scrolling area 116 controls the leftward/rightward movement of the scroll 214.

According to the touch panel the quick scrolling method thereof disclosed in the above embodiments of the invention, a moving speed of an object is calculated according to the time difference and distance between the first location and the second location of the object which are detected by the touch panel at a fist moment of time and a second moment of time, and whether to start the mechanism of fast scrolling is determined according to the moving speed. The sensing elements are linearly arranged in the scrolling area of the touch panel. The user can achieve fast scrolling by moving the scroll fast and linearly along the scrolling area. Thus, when reading a long article or checking a large area of a drawing, the user does not need to click on the buttons of the display window with the mouse. The user can quickly adjust the display range of the display window by sliding through the scrolling area with a finger, making the operation more convenient and user-friendly.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A quick scrolling method, comprising:
detecting a first location of an object at a fist moment of time by a touch panel;
detecting a second location of the object at a second moment of time;
calculating a moving speed of the object according to a time difference between the fist moment of time and the second moment of time and a distance between the first location and the second location; and
comparing the moving speed to a threshold value, and moving a scroll of a display window fast if the moving speed is greater than the threshold value.

2. The method according to claim 1, further comprising:
keeping moving the scroll of the display window fast when the object stays at the second location.

3. The method according to claim 2, further comprising:
halting the movement of the scroll of the display window when the object leaves the touch panel from the second location after having stayed at the second location for a period of time.

4. The method according to claim 1, further comprising:
keeping moving the scroll of the display window fast when the object leaves the touch panel from the second location.

5. The method according to claim 4, further comprising:
halting the movement of the scroll of the display window when the touch panel detects the object again after the object has left the touch panel.

6. The method according to claim 1, further comprising:
determining a moving direction of the scroll of the display window according to the relationship between the first location and the second location so as to.

7. The method according to claim 6, wherein the moving direction of the scroll is downward, upward, leftward or rightward.

8. A touch panel, comprising:
a panel body having at least one scrolling area;
a plurality of sensing elements disposed on the at least one scrolling area of the panel body for detecting a location of an object, wherein, the sensing elements detect a first location of the object at a fist moment of time and detect a second location of the object at a second moment of time;
a register unit having a plurality of register areas in which the data comprising the fist moment of time, the second moment of time, the first location and the second location are temporarily storied
a calculation unit for calculating a time difference between the fist moment of time and the second moment of time and a distance between the first location and the second location to further calculate a moving speed of the object;
a comparison unit for comparing the moving speed to a threshold value; and
a processing unit for generating a fast moving signal so as to move a scroll of a display window fast if the comparison unit determines that the moving speed is greater than the threshold value.

9. The touch panel according to claim 8, wherein, the arrangement of the sensing elements is linear.

10. The touch panel according to claim 8, wherein, each of the sensing elements is a capacitor element.

11. The touch panel according to claim 8, wherein, the at least one scrolling area is located at an edge of the panel body.

12. The touch panel according to claim 8, wherein, the panel body has two scrolling areas respectively adjacent to two edges of the panel body which are mutually perpendicular to each other.

13. The touch panel according to claim 8, wherein, the processing unit continues to generate the fast moving signal to keep moving the scroll of the display window fast when the object stays at the second location.

14. The touch panel according to claim 13, wherein, the processing unit further halts the movement of the scroll of the display window when the sensing elements detect that the object leaves the touch panel from the second location after having stayed at the second location for a period of time.

15. The touch panel according to claim 8, wherein, the processing unit continues to generate the fast moving signal to keep moving the scroll of the display window fast when the object leaves the touch panel from the second location.

16. The touch panel according to claim 15, wherein, after the object leaves the touch panel, the processing unit stops generating the fast moving signal so as to halt the movement of the scroll of the display window when the sensing elements again detect the object.

17. The touch panel according to claim 8, wherein, the processing unit determines a moving direction of the scroll of the display window according to the relationship between the first location and the second location.

18. The touch panel according to claim 17, wherein, the moving direction of the scroll is downward, upward, leftward or rightward.
